(19) United States
(12) Patent Application Publication
(10) Pub. No.: US 2009/0003431 A1
(43) Pub. Date: Jan. 1, 2009

(54) Method for encoding video data in a scalable manner

(76) Inventors: Lihua Zhu, Beijing (CN); Jiancong Luo, Plainsboro, NJ (US); Peng Yin, West Windsor, NJ (US); Jiheng Yang, Beijing (CN)

Correspondence Address: Joseph J. Laks;Thomson Licensing LLC, 2 Independence Way, Patent Operations, PO Box 5312, PRINCETON, NJ, 08543, US

(21) Appl. No.: 11/824,006

(22) Filed: Jun. 28, 2007

(51) Int. Cl. H04B 1/00

(52) U.S. Cl. 375/240.01

(57) ABSTRACT

The invention concerns a method for encoding video data in a scalable manner according to H.264/SVC standard. The method comprises the steps of
inserting in the encoded data stream, for the current layer, a network abstraction layer unit comprising information related to the current layer, and the video usability information for the current layer.

### FIELD OF THE INVENTION

The invention concerns a method for encoding video data in a scalable manner.

### BACKGROUND OF THE INVENTION

The invention concerns mainly the field of video coding when data can be coded in a scalable manner.

Coding video data according to several layers can be of a great help when terminals for which data are intended have different capacities and therefore cannot decode full data stream but only part of it. When the video data are coded according to several layers in a scalable manner, the receiving terminal can extract from the received bit-stream the data according to its profile.

Several video coding standards exist today which can code video data according to different layers and/or profiles. Among them, one can cite H.264/AVC, also referenced as ITU-T H.264 standard.

However, one existing problem is the overload that it creates by transmitting more data than often needed at the end-side.

Indeed, for instance in H.264/SVC or MVC (SVC standing for scalable video coding and MVC standing for multi view video coding), the transmission of several layers requests the transmission of many headers in order to transmit all the parameters requested by the different layers. In the current release of the standard, one header comprises the parameters corresponding to all the layers. Therefore, it creates a big overload on the network to transmit all the parameters for all the layers even if all layers data are not requested by the different devices to which the data are addressed.

The invention proposes to solve at least one of these drawbacks.

### SUMMARY OF THE INVENTION

To this end, the invention proposes a method for encoding video data in a scalable manner according to H.264/SVC standard. According to the invention, the method comprises the steps of
inserting in the encoded data stream, for the current layer, a network abstraction layer unit comprising information related to the current layer, and the video usability information for the current layer.

According to a preferred embodiment, the abstraction network abstraction layer unit comprises a link to the Sequence Parameter Set that the current layer is linked to.

According to a preferred embodiment the information related to the current layer comprises information chosen among
the spatial level,
the temporal level,
the quality level,
and any combination of these information.

In some coding methods, the parameters for all the layers are all transmitted as a whole, no matter how many layers are transmitted. Therefore, this creates a big overload on the network. This is mainly due to the fact that some of the parameters are layer dependant and some others are common to all layers and therefore, one header being defined for all parameters, all layer dependant and independent parameters are transmitted together.

Thanks to the invention, the layer dependant parameters are only transmitted when needed, that is when the data coded according to these layers are transmitted instead of transmitting the whole header comprising the parameters for all the layers.

### BRIEF DESCRIPTION OF THE DRAWINGS

Other characteristics and advantages of the invention will appear through the description of a non-limiting embodiment of the invention, which will be illustrated, with the help of the enclosed drawings.

FIG. 1 represents the structure of the NAL unit used for scalable layers coding according to the prior art,

FIG. 2 represent an embodiment of the structure as proposed in the current invention,

FIG. 3 represents an overview of the scalable video coder according to a preferred embodiment of the invention,

FIG. 4 represents an overview of the data stream according to a preferred embodiment of the invention,

FIG. 5 represents an example of a bitstream according to a preferred embodiment of the invention,

### DETAILED DESCRIPTION OF PREFERRED EMBODIMENTS

According to the preferred embodiment described here, the video data are coded according to H264/SVC. SVC proposes the transmission of video data according to several spatial levels, temporal levels, and quality levels. For one spatial level, one can code according to several temporal levels and for each temporal level according to several quality levels. Therefore when m spatial levels are defined, n temporal levels and O quality levels, the video data can be coded according to m*n*O different levels. According to the client capabilities, different layers are transmitted up to a certain level corresponding to the maximum of the client capabilities.

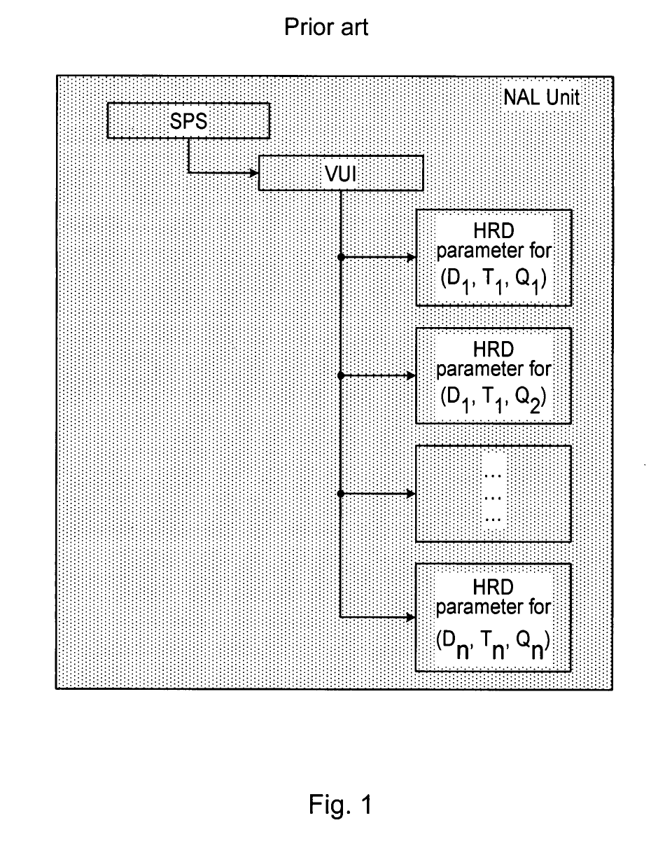

As shown on FIG. 1 representing the prior art of the invention, currently in SVC, SPS is a syntax structure which contains syntax elements that apply to zero or more entire coded video sequences as determined by the content of a seq_parameter_set_id syntax element found in the picture parameter set referred to by the pic parameter_set_id syntax element found in each slice header. In SVC, the values of some syntax elements conveyed in the SPS are layer dependant. These syntax elements include but are not limited to, the timing information, HRD (standing for “Hypothetical Reference Decoder”) parameters, bitstream restriction information. Therefore, it is necessary to allow the transmission of the aforementioned syntax elements for each layer.

One Sequence Parameter Set (SPS) comprises all the needed parameters for all the corresponding spatial (Dᵢ), temporal (Tᵢ) and quality (Qᵢ) levels whenever all the layers are transmitted or not

SPS comprises the VUI (standing for Video Usability Information) parameters for all the layers. The VUI parameters represent a very important quantity of data as they comprise the HRD parameters for all the layers. In practical applications, as the channel rate is constrained, only certain layers are transmitted through the network. As SPS represent a basic syntax element in SVC, it is transmitted as a whole. Therefore, no matter which layer transmitted, the HRD parameters for all the layers are transmitted.

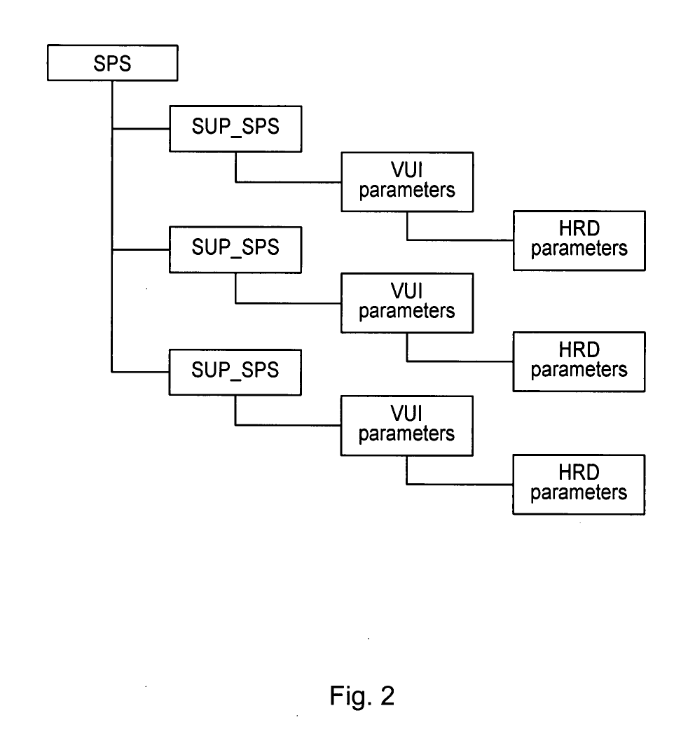

As shown on FIG. 2, in order to reduce the overload of the Sequence Parameter set (SPS) for scalable video coding, the invention proposes a new NAL unit called SUP_SPS. A SUP_SPS parameter is defined for each layer. All the layers sharing the same SPS have a SUP_SPS parameter which contains an identifier, called sequence_parameter_set_id, to be linked to the SPS they share.

The SUP_SPS is described in the following table:

TABLE 1

| | |
|---|---|
| C | Descriptor |

| | | |
|---|---|---|
| sup_seq_parameter_set_svc ( ) { | | |
| sequence_parameter_set_id | 0 | ue(v) |
| temporal_level | 0 | u(3) |
| dependency_id | 0 | u(3) |
| quality_level | 0 | u(2) |
| vui_parameters_present_svc_flag | 0 | u(1) |
| if( vui_parameters_present_svc_flag ) | | |
| svc_vui_parameters( ) | | |
| } | | |

sequence_parameter_set_id identifies the sequence parameter set which current SUP_SPS maps to for the current layer.
temporal_level, dependency_id and quality_level specify the temporal level, dependency identifier and quality level for the current layer.
vui_parameters_present_svc_flag equals to 1 specifies that svc_vui_parameters( ) syntax structure as defined below is present. vui_parameters_present_svc_flag equals to 0 specifies that svc_vui_parameters( ) syntax structure is not present.

Next table gives the svc_vui_parameter as proposed in the current invention. The VUI message is therefore separated according to the property of each layer and put into a supplemental sequence parameter set.

TABLE 2

| | C | Descriptor |
|---|---|---|
| svc_vui_parameters( ) { | | |
| timing_info_present_flag | 0 | u(1) |
| If( timing_info_present_flag ) { | | |
| num_units_in_tick | 0 | u(32) |
| time_scale | 0 | u(32) |
| fixed_frame_rate_flag | 0 | u(1) |
| } | | |
| nal_hrd_parameters_present_flag | 0 | u(1) |
| If( nal_hrd_parameters_present_flag ) | | |
| hrd_parameters( ) | | |
| vcl_hrd_parameters_present_flag | 0 | u(1) |
| If( vcl_hrd_parameters_present_flag ) | | |
| hrd_parameters( ) | | |
| If( nal_hrd_parameters_present_flag \|\| | | |
| vcl_hrd_parameters_present_flag ) | | |
| low_delay_hrd_flag | 0 | u(1) |
| pic_struct_present_flag | 0 | u(1) |
| bitstream_restriction_flag | 0 | u(1) |
| If( bitstream_restriction_flag ) { | | |
| motion_vectors_over_pic_boundaries_flag | 0 | u(1) |
| max_bytes_per_pic_denom | 0 | ue(v) |
| max_bits_per_mb_denom | 0 | ue(v) |
| log2_max_mv_length_horizontal | 0 | ue(v) |
| log2_max_mv_length_vertical | 0 | ue(v) |
| num_reorder_frames | 0 | ue(v) |
| max_dec_frame_buffering | 0 | ue(v) |
| } | | |
| } | | |

The different fields of this svc_vui_parameter( ) are the ones that are defined in the current release of the standard H.264/SVC under JVT-U201 annex E E.1.

The SUP_SPS is defined as a new type of NAL unit. The following table gives the NAL unit codes as defined by the standard JVT-U201 and modified for assigning type 24 for the SUP_SPS.

TABLE 3

| | Content of NAL unit and RBSP | |
|---|---|---|
| nal_unit_type | syntax structure | C |
| 0 | Unspecified | |
| 1 | Coded slice of a non-IDR picture | 2, |
| | slice_layer_without_partitioning_rbsp( ) | 3, 4 |
| . . . | . . . | . . . |
| 24 | sup_seq_parameter_set_svc( ) | |
| 25 . . . 31 | Unspecified | |

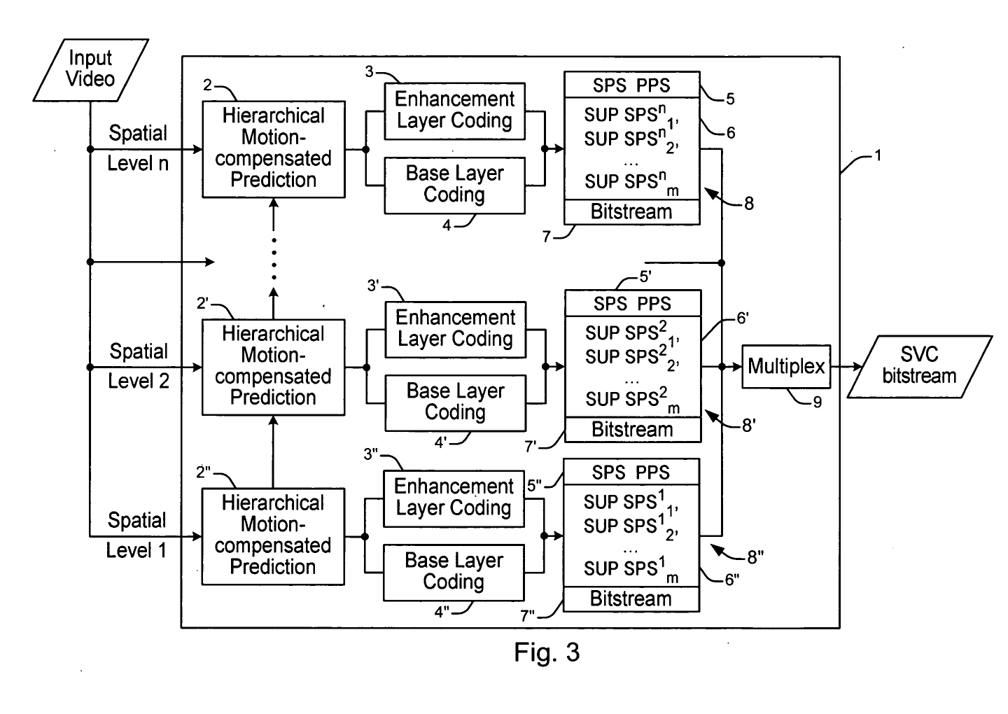

FIG. 3 shows an embodiment of a scalable video coder 1 according to the invention.

A video is received at the input of the scalable video coder 1.

The video is coded according to different spatial levels. Spatial levels mainly refer to different levels of resolution of the same video. For example, as the input of a scalable video coder, one can have a CIF sequence (352 per 288) or a QCIF sequence (176 per 144) which represent each one spatial level.

Each of the spatial level is sent to a hierarchical motion compensated prediction module. The spatial level 1 is sent to the hierarchical motion compensated prediction module 2″, the spatial level 2 is sent to the hierarchical motion compensated prediction module 2′ and the spatial level n is sent to the hierarchical motion compensated prediction module 2.

The spatial levels being coded on 3 bits, using the dependency_id, therefore the maximum number of spatial levels is 8.

Once hierarchical motion predicted compensation is done, two kinds of data are generated, one being motion which describes the disparity between the different layers, the other being texture, which is the estimation error.

For each of the spatial level, the data are coded according to a base layer and to an enhancement layer. For spatial level 1, data are coded through enhancement layer coder 3″ and base layer coder 4″, for spatial level 2, data are coded through enhancement layer coder 3′ and base layer coder 4′, for spatial level 1, data are coded through enhancement layer coder 3 and base layer coder 4.

After the coding, the headers are prepared and for each of the spatial layer, a SPS and a PPS messages are created and several SUP_SPS messages.

For spatial level 1, as represented on FIG. 1, SPS and PPS 5″ are created and a set of SUP_SPS₁¹, SUP_SPS₂¹, . . . , SUP_SPS_{m*O}¹ are also created according to this embodiment of the invention.

For spatial level 2, as represented on FIG. 1, SPS and PPS 5′ are created and a set of SUP_SPS₁², SUP_SPS₂², . . . , SUP_SPS_{m*O}² are also created according to this embodiment of the invention.

For spatial level n, as represented on FIG. 1, SPS and PPS 5 are created and a set of SUP_SPS₁ⁿ, SUP_SPS₂ⁿ, . . . , SUP_SPS_{m*O}ⁿ are also created according to this embodiment of the invention.

The bitstreams encoded by the base layer coding modules and the enhancement layer coding modules are following the plurality of SPS, PPS and SUP_SPS headers in the global bitstream.

On FIG. 3, 8″ comprises SPS and PPS 5″, SUP_SPS₁¹, SUP_SPS₂¹, . . . , SUP_SPS_{m*O}¹ 6″ and bitstream 7″ which constitute all the encoded data associated with spatial level 1.

On FIG. 3, 8′ comprises SPS and PPS 5′, SUP_SPS₁², SUP_SPS₂², . . . , SUP_SPS_{m*O}² 6′ and bitstream 7′ which constitute all the encoded data associated with spatial level 2.

On FIG. 3, 8 comprises SPS and PPS 5, SUP_SPS₁ⁿ, SUP_SPS₂ⁿ, . . . , SUP_SPS_{m*O}ⁿ 6 and bitstream 7 which constitute all the encoded data associated with spatial level n.

The different SUP_SPS headers are compliant with the headers described in the above tables.

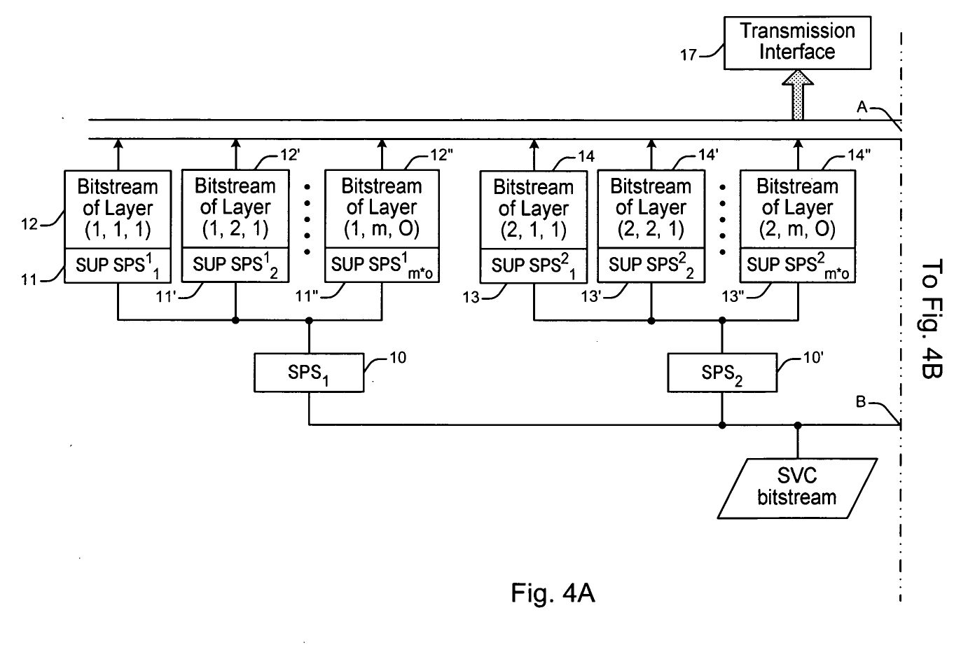

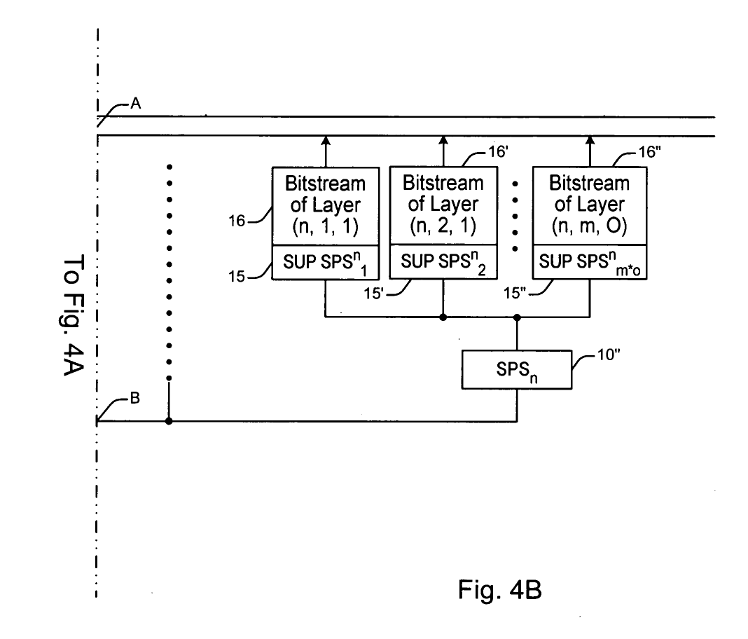

FIG. 4 represents a bitstream as coded by the scalable video encoder of FIG. 1.

The bitstream comprises one SPS for each of the spatial levels. When m spatial levels are encoded, the bitstream comprises SPS1, SPS2 and SPSm represented by 10, 10′ and 10″ on FIG. 2.

In the bitstream, each SPS coding the general information relative to the spatial level, is followed by a header 10 of SUP_SPS type, itself followed by the corresponding encoded video data corresponding each to one temporal level and one quality level.

Therefore, when one level corresponding to one quality level is not transmitted, the corresponding header is also not transmitted as there is one header SUP_SPS corresponding to each level.

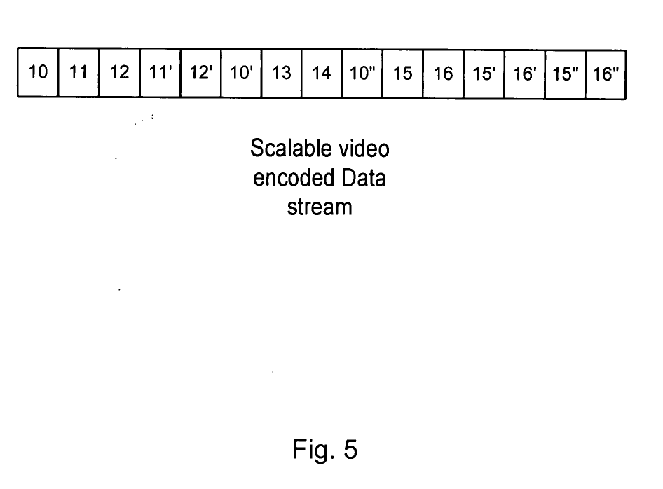

So, let's take an example to illustrate the data stream to be transmitted as shown on FIG. 5.

FIG. 5 illustrates the transmission of the following levels. On FIG. 5 only the references to the headers are mentioned, not the encoded data The references indicated in the bitstream correspond to the references used in FIG. 4.

The following layers are transmitted:
spatial layer 1
   temporal level 1
      Quality level 1
   temporal level 2
      Quality level 1
spatial layer 2
   temporal level 1
      a quality level 1
spatial layer 3
   temporal level 1
      Quality level 1
   temporal level 2
      Quality level 1
   temporal level 3
      Quality level 1

Therefore, one can see that not all the different parameters for all the layers are transmitted but only the ones corresponding to the current layer as they are comprised in the SUP_SPS messages and no more in the SPS messages.

1. Method for encoding video data in a scalable manner according to H.264/SVC standard wherein it comprises the steps of
inserting in the encoded data stream, for the current layer, a network abstraction layer unit comprising information related to the current layer, and the video usability information for the current layer.

2. Method according to claim 1 wherein said abstraction network abstraction layer unit comprises a link to the Sequence Parameter Set that the current layer is linked to.

3. Method according to claim 1 wherein said information related to the current layer comprises information chosen among
the spatial level,
the temporal level,
the quality level,
and any combination of these information.
